(19) United States
(12) Patent Application Publication
(10) Pub. No.: US 2017/0024025 A1
(43) Pub. Date: Jan. 26, 2017

(54) ELECTRONIC DEVICE AND METHOD THEREOF FOR PROVIDING CONTENT

(71) Applicant: SAMSUNG ELECTRONICS CO., LTD., Suwon-si (KR)

(72) Inventor: Hoon CHOI, Suwon-si (KR)

(73) Assignee: SAMSUNG ELECTRONICS CO., LTD., Suwon-si (KR)

(21) Appl. No.: 15/217,515

(22) Filed: Jul. 22, 2016

(30) Foreign Application Priority Data
Jul. 24, 2015 (KR) 10-2015-0105290

(51) Int. Cl. G06F 3/0346; G06F 3/041

(52) U.S. Cl. CPC G06F 3/0346; G06F 3/0414

(57) ABSTRACT

An electronic device for providing content includes a sensor configured to sense a user input with respect to the electronic device and a controller configured to stop providing the content in response to determining that the electronic device is in a moving state based on the sensed user input while providing the content, and to resume providing the content in response to determining that the electronic device exits the moving state.

### CROSS-REFERENCE TO RELATED APPLICATION

This application claims the benefit of Korean Patent Application No. 10-2015-0105290, filed on Jul. 24, 2015, in the Korean Intellectual Property Office, the disclosure of which is incorporated herein by reference in its entirety.

### BACKGROUND

1. Field

Apparatuses and methods consistent with exemplary embodiments relate to an electronic device and a method for providing content, and more particularly, to an electronic device and a method for providing content based on movement of the electronic device.

2. Description of the Related Art

Display apparatuses have functions of displaying images for users to watch. Users may watch broadcast content through the display devices. The display device displays broadcast content selected by the user from broadcast signals transmitted from a broadcasting station. At present, the current global trend is toward digital broadcasting and away from analog broadcasting.

Digital broadcasting refers to broadcasting of digital images and digital voice signals. Compared to analog broadcasting, digital broadcasting has less data loss due to being robust against external noise, is more favorable to error correction, has a higher resolution, and provides a clearer screen. In addition, unlike analog broadcasting, digital broadcasting may also provide an interactive service.

Moreover, smart televisions (TVs) providing various content in addition to a digital broadcasting function have been provided. Thus, there is a need for intensive research into providing various and convenient viewing environments as well as providing content to users.

### SUMMARY

One or more exemplary embodiments provide an electronic device and method for providing content based on movement of the electronic device.

Additional aspects will be set forth in part in the description which follows and, in part, will be apparent from the description, or may be learned by practice of the presented embodiments.

According to an aspect of an exemplary embodiment, there is provided an electronic device for providing content including a sensor configured to sense a user input with respect to the electronic device and a controller configured to stop providing the content in response to determining that the electronic device is in a moving state based on the sensed user input while providing the content, and to resume providing the content in response to determining that the electronic device exits the moving state.

The controller may be configured to, in response to determining that the electronic device exits the moving state, resume providing the content from a part of the content being provided at a point in time when the providing the content is stopped.

The electronic device may further include a grip portion mounted on the electronic device, wherein the sensor is configured to sense the user input in response to the grip portion being touched by the user.

The controller may be configured to determine that the electronic device exits the moving state based on the touched user input with respect to the grip portion being released.

The electronic device may further include a power supply unit configured to supply power and a display, wherein the controller is configured to control the power supply unit to stop supplying the power to the display in response to a preset time being elapsed after determining that the electronic device is in the moving state.

The electronic device may further include a display, wherein the display is configured to provide an interface for a user to input whether to provide the content in response to determining that the electronic device exits the moving state; and wherein the controller is configured to resume providing the content based on the user input with respect to the interface.

The electronic device may further include a tuner unit configured to receive broadcast content, wherein the controller is configured to stop providing the broadcast content and to record the broadcast content received from a point in time when the providing the broadcast content is stopped in response to determining that the electronic device is in the moving state.

According to an aspect of another exemplary embodiment, there is provided a method of providing content including sensing a user input with respect to an electronic device, stopping providing the content in response to determining that the electronic device is in a moving state based on the sensed user input while providing the content, and resuming providing the content in response to determining that the electronic device exits the moving state.

The resuming providing the content comprises providing the content from a part of the content being provided at a point in time when the providing the content is stopped.

The sensing the user input comprises sensing the user input in response to a grip portion mounted on the electronic device being touched by the user.

The resuming providing the content comprises determining that the electronic device exits the moving state based on the touched user input with respect to the grip portion being released.

The method may further include controlling a power supply unit to stop supplying power to a display in response to a preset time being elapsed after determining that the electronic device is in the moving state.

The resuming providing the content comprises providing an interface for a user to input whether to provide the content to a display in response to determining that the electronic device exits the moving state, and providing the content based on the user input with respect to the interface.

The stopping providing the content comprises stopping providing broadcast content and recording the broadcast content received from a point in time when the providing the broadcast content is stopped in response to determining that the electronic device is in the moving state.

### BRIEF DESCRIPTION OF THE DRAWINGS

The above and/or other aspects of the disclosure will become apparent and more readily appreciated from the following description of the exemplary embodiments, taken in conjunction with the accompanying drawings in which:

FIG. 1 is a diagram for briefly describing an exemplary embodiment;

FIGS. 2 and 3 are block diagrams of an electronic device according to an exemplary embodiment;

FIGS. 4 through 6 and 7A-7D are views for describing examples of a grip portion mounted on an electronic device, according to exemplary embodiments;

FIG. 8 is a flowchart illustrating a method of controlling an electronic device according to an exemplary embodiment;

FIG. 9 is a flowchart for describing an example in which power supply to a display of an electronic device is blocked, according to an exemplary embodiment;

FIG. 10 is a view for describing an example in which power supply to a display of an electronic device is blocked, according to an exemplary embodiment;

FIG. 11 is a flowchart for describing an example in which content is automatically provided, according to an exemplary embodiment;

FIG. 12 is a view for describing an example in which content is automatically provided, according to an exemplary embodiment;

FIG. 13 is a flowchart for describing an example in which content is provided based on a user input, according to an embodiment;

FIG. 14 is a view for describing an example in which content is provided based on a user input, according to an exemplary embodiment;

FIG. 15 is a flowchart for describing an example in which broadcast content is recorded, according to an exemplary embodiment; and

FIGS. 16 through 17 are views for describing an example in which broadcast content is recorded, according to exemplary embodiments.

### DETAILED DESCRIPTION

Hereinafter, exemplary embodiments of the present disclosure will be described in detail with reference to the attached drawings to allow those of ordinary skill in the art to easily carry out the exemplary embodiments. However, the present disclosure may be implemented in various forms, and are not limited to the exemplary embodiments described herein. To clearly describe the present disclosure, parts that are not associated with the description have been omitted from the drawings, and throughout the specification, identical reference numerals refer to identical parts.

Objects, features, and advantages of the present disclosure will become apparent from the following detailed description associated with the attached drawings. Various changes may be made to the present disclosure and the present disclosure may have various exemplary embodiments which will be described in detail with reference to the drawings. Throughout the specification, identical reference numerals refer to identical elements in principle. Moreover, detailed descriptions of well-known functions or elements associated with the present disclosure will be omitted if they unnecessarily obscure the subject matter of the present disclosure. In addition, numbers (e.g., 1st, 2nd, first, second, etc.) used in the description of the specification are merely identification symbols for distinguishing one element from another element.

Hereinafter, an electronic device associated with the present disclosure will be described in more detail with reference to the drawings. Suffixes “module” and “unit” used for elements in the description may be given or used only considering easiness in completing the specification, and do not have any distinguishable meaning or role.

Examples of an electronic device described herein may include an analog television (TV), a digital TV, a three-dimensional (3D) TV, a smart TV, a light emitting diode (LED) TV, an organic light emitting diode (OLED) TV, a plasma TV, a monitor, and so forth. Moreover, it would be easily appreciated by those of ordinary skill in the art that examples of an electronic device according to the present disclosure may also include a desktop computer, a cellular phone, a smartphone, a tablet personal computer (PC), a laptop computer, a digital broadcasting terminal, a personal digital assistant (PDA), a portable multimedia player (PMP), a navigation system, and the like.

In a description of the exemplary embodiments, when a part is connected to another part, the part is not only directly connected to another part but also electrically connected to another part with another device intervening in them. If it is assumed that a certain part includes a certain component, the term ‘including’ means that a corresponding component may further include other components unless a specific meaning opposed to the corresponding component is written.

Hereinafter, exemplary embodiments will be described with reference to the accompanying drawings.

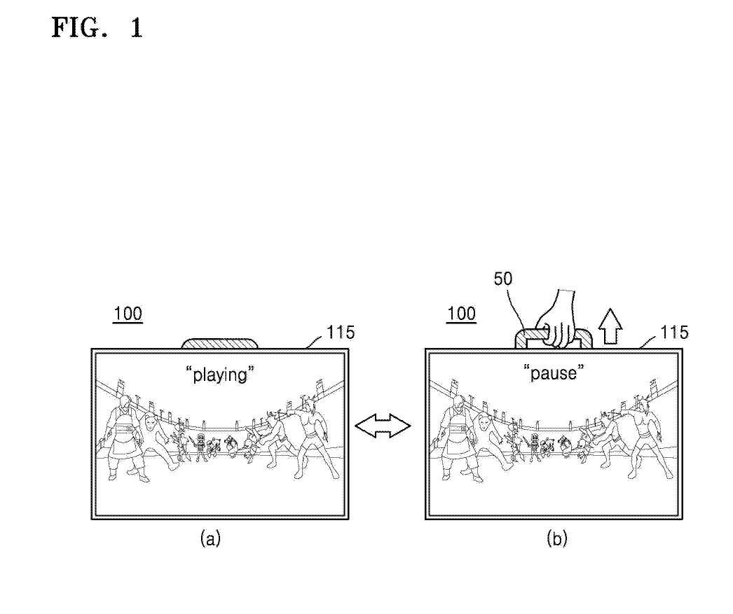

FIG. 1 is a diagram for briefly describing an exemplary embodiment.

Referring to (a) and (b) of FIG. 1, an electronic device 100 may be a portable digital TV having a grip portion 50 mounted thereon. However, the electronic device 100 is not limited to the illustration. For example, the electronic device 100 may be a PMP, a portable terminal, or an Internet-of-Things (IoT)-network-based device, which has the grip portion 50 mounted thereon and includes a display 115.

The electronic device 100 may have a size that needs the grip portion 50 when a user moves carrying the electronic device 100. For example, the size of the electronic device 100 may be about 15 inches, about 17 inches, about 19 inches, or about 27 inches, without being limited thereto. The foregoing inches may be based on a size of a display included in the electronic device 100.

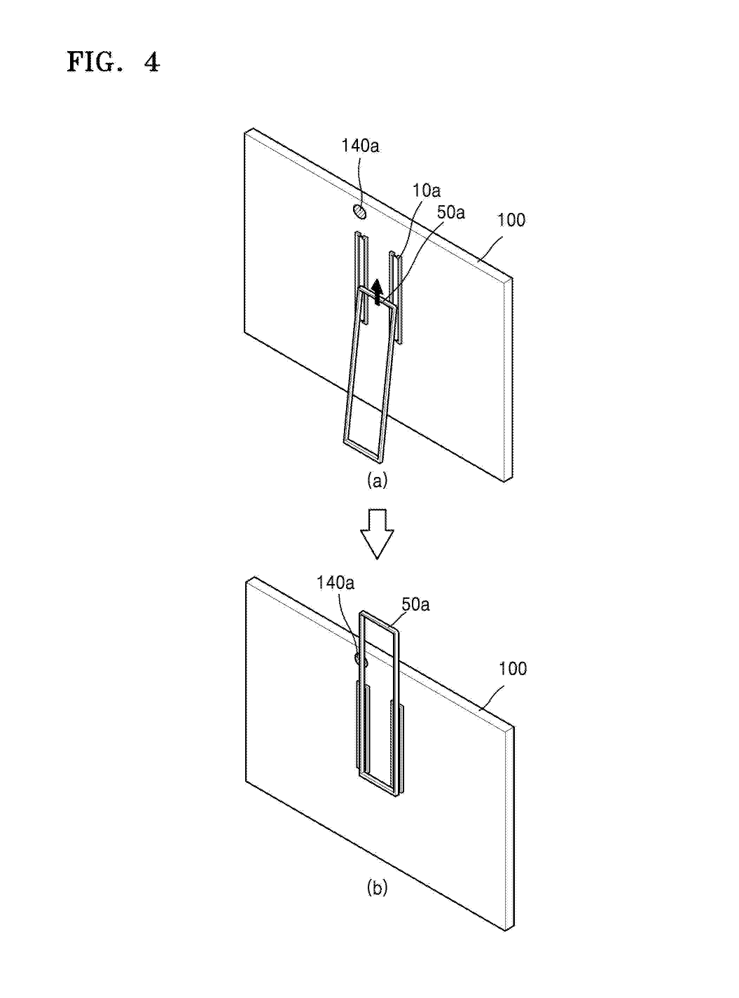

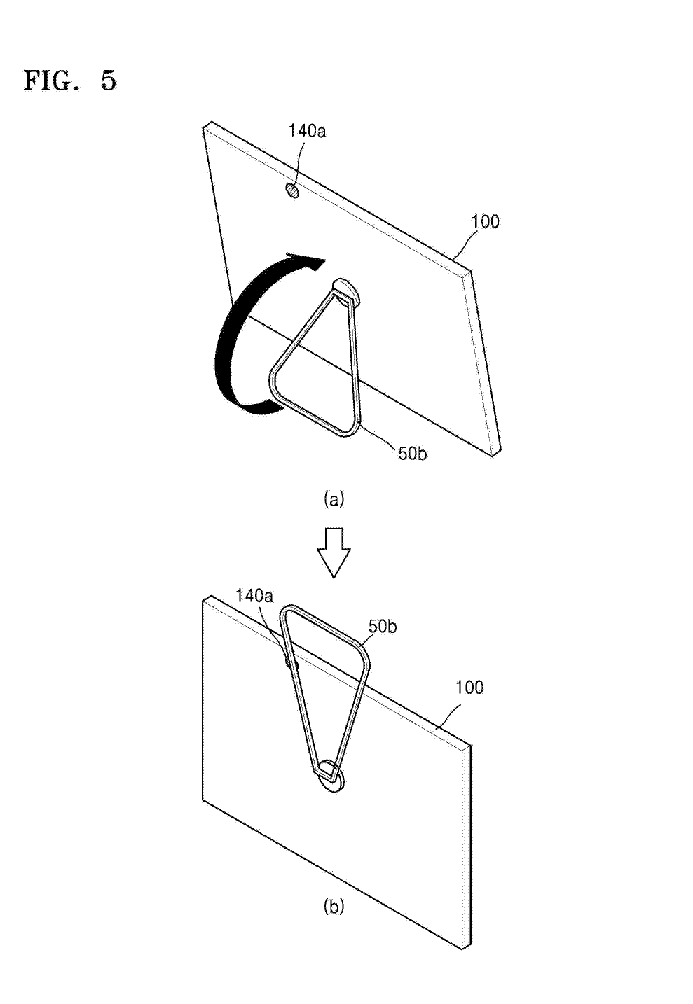

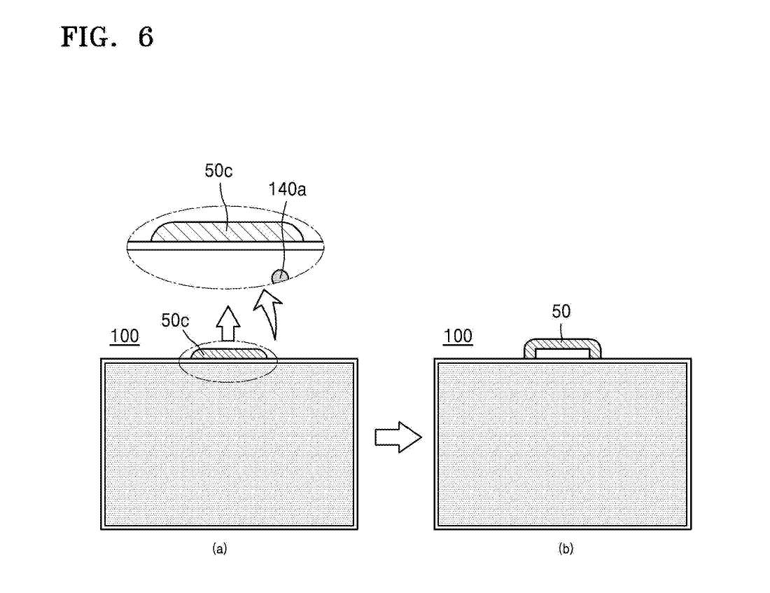

A state of the grip portion 50 according to an exemplary embodiment may be such that the electronic device 100 may not be held by a user's hand when the electronic device 100 is not a moving state, as illustrated in (a) of FIG. 1. The grip portion 50 according to an exemplary embodiment may be inserted into a partial region of the electronic device 100 (see (a) of FIG. 1 or (a) of FIG. 6) when the electronic device 100 is not a moving state or may be used as a support when the electronic device 100 is not a moving state (see (a) of FIG. 4 or (a) of FIG. 5).

As illustrated in (b) of FIG. 1, the state of the grip portion 50 according to an exemplary embodiment may be such that the electronic device 100 may be held by the user when being carried by the user. According to an exemplary embodiment, the electronic device 100 may be transformed into a form that is suitable for the user to move conveniently holding the electronic device 100 by using the grip portion 50.

Meanwhile, according to an exemplary embodiment, the electronic device 100 may provide content.

The content may include video, photos, music, texts, Internet-based content, broadcasting content, and so forth, without being limited thereto.

According to an exemplary embodiment, if content provided by the electronic device 100 includes an image, providing the content may include displaying the content on the display 115.

The electronic device 100 provides content stored therein. In this case, the electronic device 100 provides the content stored therein based on a user input being input using a user input unit of the electronic device 100 and/or information received from an external device.

Meanwhile, according to an exemplary embodiment, the electronic device 100 may provide content received from the external device. The content received from the external device may include broadcasting content received through a tuner unit 135. The content received from the external device may include content received from an IoT-network-based device (e.g., a smart home appliance or a smart office device).

Referring to FIG. 1, according to an exemplary embodiment, the electronic device 100 stops providing content (see (b) of FIG. 1) if the electronic device 100 determines that the electronic device 100 is in a moving state while providing content (see (a) of FIG. 1). According to an exemplary embodiment, the controller 180 determines that the electronic device 100 is in the moving state based on a touched user input with respect to the grip portion 50.

Once determining that the electronic device exits the moving state, the electronic device 100 resumes providing the content (see (a) of FIG. 1). According to an exemplary embodiment, the controller 180 determines that the electronic device 100 exits the moving state based on the touched user input with respect to the grip portion 50 being released.

For example, if the user moves while watching video on a portable TV placed on a table, the portable TV may automatically stop playing content. If the user situates the portable TV after arriving at a destination, the portable TV resumes playing the video the user has watched, continuously from a part of the video corresponding to a point in time when the playback of the video is stopped. As a result, when the user of the electronic device desires to move while watching the portable TV, the user may watch the video having been played on the portable TV continuously with no missing part of the video, without stopping the video and without resuming playing the video at the destination.

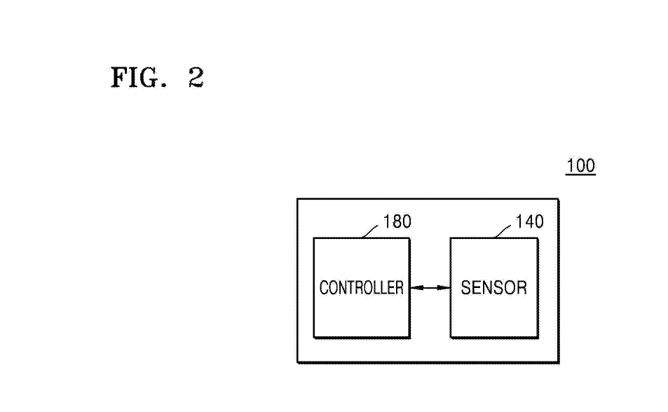

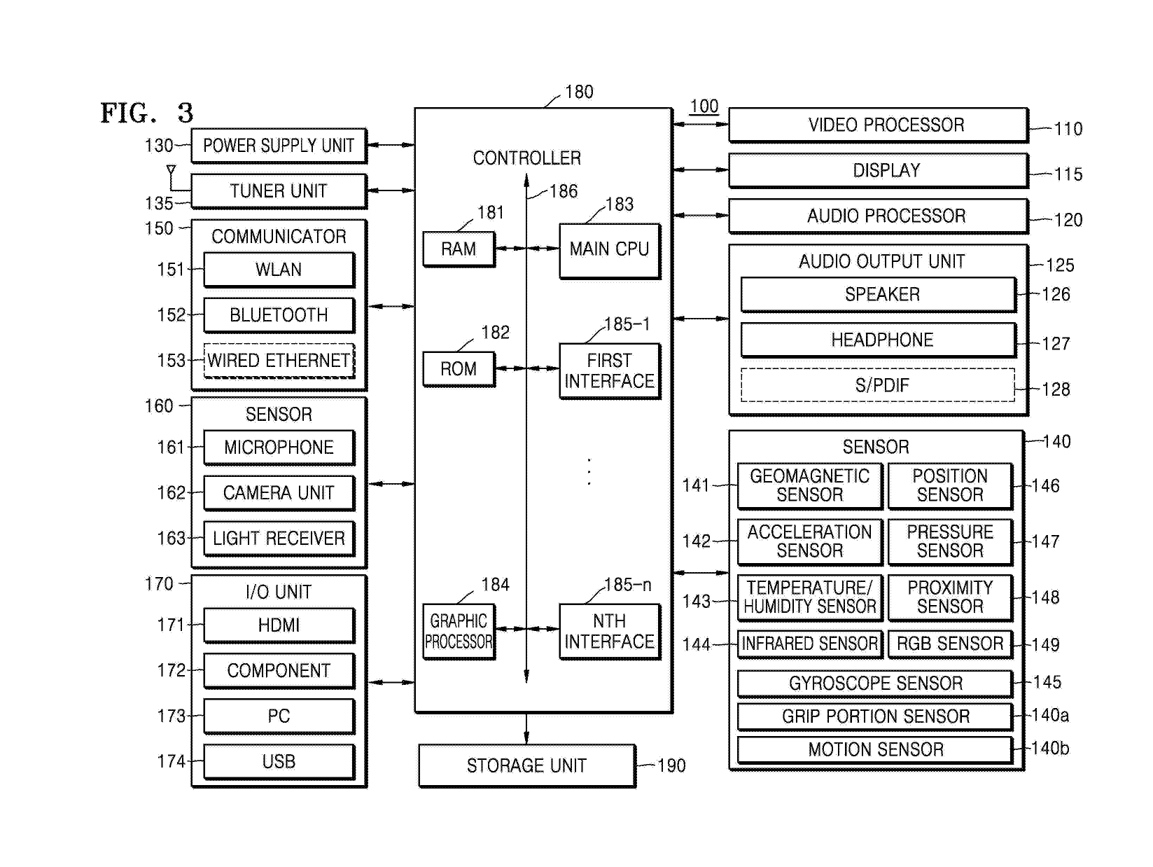

FIGS. 2 and 3 are block diagrams of an electronic device according to an exemplary embodiment.

Referring to FIG. 2, the electronic device 100 may include a sensor 140 and a controller 180. However, all the illustrated elements are not essential elements. The electronic device 100 may include a larger or smaller number of elements than the illustrated elements.

For example, as illustrated in FIG. 3, the electronic device 100 according to an exemplary embodiment may further include a video processor 110, an audio processor 120, an audio output unit 125, a power source unit 130, a tuner unit 135, a communicator 150, a sensor 160, an input/output (I/O) unit 170, and a storing unit 190.

Hereinbelow, the foregoing elements will be described in detail.

The video processor 110 processes video data received by the electronic device 100. The video processor 110 performs various image processing, such as decoding, scaling, noise filtering, frame rate conversion, resolution conversion, etc., with respect to video data.

The display 115 displays video included in a broadcast signal received through the tuner unit 135 on a screen under control of the controller 180. The display 115 displays content (e.g., video) input through the communicator 150 or the I/O unit 170. The display 115 outputs an image stored in the storing unit 190 under control of the controller 180. The display 115 displays a voice user interface (UI) (including, e.g., a voice command guide) for performing a voice recognition task corresponding to voice recognition or a motion UI (e.g., a user motion guide for motion recognition) for performing a motion recognition task corresponding to motion recognition.

According to an exemplary embodiment, the display 115 displays content under control of the controller 180. The display 115 displays content being played under control of the controller 180 when the electronic device 100 is not in the moving state.

According to an exemplary embodiment, the display 115 displays a still image corresponding to a point in time when providing of the content is stopped, under control of the controller 180, if the electronic device 100 determines that the electronic device 100 is in the moving state.

According to an exemplary embodiment, the display 115 resumes providing the content continuously from a part of the content corresponding to the point in time when providing of the content is stopped, under control of the controller 180, if the electronic device 100 determines that the electronic device 100 exits the moving state.

The audio processor 120 processes audio data. The audio processor 120 performs various processing such as decoding, amplification, noise filtering, etc., with respect to the audio data. Meanwhile, the audio processor 120 may include a plurality of audio processing modules for processing audio corresponding to a plurality of contents.

The audio output unit 125 outputs audio included in a broadcast signal received through the tuner unit 135 under control of the controller 180. The audio output unit 125 outputs audio (e.g., voice, sound, etc.) input through the communicator 150 or the I/O unit 170. The audio output unit 125 outputs audio stored in the storing unit 190 under control of the controller 180. The audio output unit 125 may include at least one of a speaker 126, a headphone output terminal 127, and a Sony/Phillips digital interface (S/PDIF) output terminal 128. The audio output unit 125 may include a combination of the speaker 126, the headphone output terminal 127, and the S/PDIF output terminal 128.

The power supply unit 130 supplies power, which is input from an external power source, to the internal elements 110 through 190 of the electronic device 100, under control of the controller 180. The power supply unit 130 supplies power, which is output from one or more batteries (not shown) included in the electronic device 100, to the internal elements 110 through 190, under control of the controller 180.

According to an exemplary embodiment, the display 130 blocks power supply to the display 115 under control of the controller 180, if a preset time has elapsed after the electronic device 100 determines that the electronic device 100 is in the moving state.

The tuner unit 135 selects a frequency of a channel the electronic device 100 desires to receive from among many electric wave components by tuning the frequency through amplification, mixing, resonance, or the like with respect to a broadcast signal received wiredly or wirelessly. The broadcast signal may include audio, video, and additional information (e.g., an electronic program guide (EPG)).

The tuner unit 135 receives a broadcast signal in a frequency band corresponding to a channel number (e.g., cable broadcasting #506) based on a user input (e.g., a control signal received from a control device, such as a channel number input, a channel up-down input, and a channel input on an EPG screen).

The tuner unit 135 receives a broadcast signal from various sources such as terrestrial broadcasting, cable broadcasting, satellite broadcasting, Internet broadcasting, and so forth. The tuner unit 135 receives a broadcast signal from a source such as analog broadcasting, digital broadcasting, or the like. The broadcast signal received through the tuner unit 135 is decoded (e.g., audio-decoded, video-decoded, or additional-information-decoded) and separated into audio, video, and/or additional information. The separated audio, video, and/or additional information is stored in the storing unit 190 under control of the controller 180.

There may be one or a plurality of tuner units 135 in the electronic device 100. The tuner unit 135 may be implemented as all-in-one with the electronic device 100 or as a separate device including a tuner unit electrically connected with the electronic device 100 (e.g., a set-top box (not shown) or a tuner unit (not shown) connected to the I/O unit 170).

The tuner unit 135 according to an exemplary embodiment receives a broadcast signal and outputs the received broadcast signal to the display 115, under control of the controller 180.

The sensor 140 senses a state of the electronic device 100 or a state near the electronic device 100, and delivers sensed information to the controller 130. The sensor 140 may include, but not limited to, at least one of a geomagnetic sensor 141, an acceleration sensor 142, a temperature/humidity sensor 143, an infrared sensor 144, a gyroscope sensor 145, a positioning sensor (e.g., a global positioning system (GPS)) 146, a pressure sensor 147, a proximity sensor 148, and a red/green/blue (RGB) sensor (or an illuminance sensor) 149. A function of each sensor may be intuitively construed from a name of each sensor by those of ordinary skill in the art, and thus will not be described in detail.

The sensor 140 according to an exemplary embodiment may include a grip portion sensor 140a and a motion sensor 140b.

According to an exemplary embodiment, the grip portion sensor 140a senses if the grip portion 50 is touched by the user.

For example, the grip portion sensor 140a may be implemented with a on/off switch. The grip portion sensor 140a may be implemented with a proximity sensor or a contact sensor. The grip portion sensor 140a may also be implemented with a touch sensor capable of sensing a user's touch input. The grip portion sensor 140a may be implemented as a light sensor, without being limited thereto.

According to an exemplary embodiment, the motion sensor 140b senses that the electronic device 100 is on the move.

For example, the motion sensor 140b may refer to, but not limited to, at least one of the acceleration sensor 142, the gyroscope sensor 145, the geomagnetic sensor 141, and a gravity sensor.

The sensor 140 may include a sensor for sensing a touch input, which is input through an input means, and a sensor for sensing a touch input, which is input by the user. In this case, the sensor for sensing the touch input, which is input by the user, may be included in a touch screen or a touch pad. The sensor for sensing the touch input, which is input through the input means, may be positioned under or in a touch screen or a touch pad.

The communicator 150 connects the electronic device 100 with an external device (e.g., an audio device, etc.) under control of the controller 180. The controller 180 transmits/receives content to/from an external device connected through the communicator 150, downloads an application from the external device, or browses the web.

The communicator 150 may include at least one of a wireless local area network (WLAN) 151, Bluetooth 152, and wired Ethernet 153, depending on capabilities and structure of the electronic device 100. The communicator 150 may include a combination of the WLAN 151, the Bluetooth 152, and the wired Ethernet 153.

The communicator 150 may include, but not limited to, a Bluetooth Low Energy (BLE) communication unit, a near field communication (NFC) unit, a WLAN (WiFi) communication unit, a ZigBee communication unit, an infrared Data Association (IrDA) communication unit, a WiFi Direct (WFD) communication unit, an ultra wideband (UWB) communication unit, and an Ant+ communication unit.

The communication unit 150 transmits and receives a radio signal to and from at least one of a base station, an external terminal, and a server over a mobile communication network. Herein, the radio signal may include various forms of data corresponding to transmission/reception of a voice call signal, a video communication call signal, or a text/multimedia message.

The communication unit 150 may include a broadcasting receiver that receives a broadcast signal and/or broadcasting-related information from an external source through a broadcasting channel. The broadcasting channel may include a satellite channel and a terrestrial channel.

The communicator 150 receives a control signal from an external control device under control of the controller 180. The control signal may be implemented as a Bluetooth type, an RF signal type, or a WiFi type.

The sensor 160 senses a voice, an image, or an interaction of the user.

The microphone 161 receives an uttered voice of the user. The microphone 161 converts the received voice into an electric signal and outputs the electric signal to the controller 180. The user's voice may include, for example, a voice corresponding to a menu or a function of the electronic device 100. A recognition range of the microphone 161 is recommended to fall within a range of about 4 m from the microphone 161 to a user's position, and may vary with the volume of the voice of the user and a peripheral environment (e.g., a speaker sound, a surrounding noise, etc.)

The microphone 161 may be implemented as an integral or separate type with the electronic device 100. The separated microphone 161 is electrically connected with the electronic device 100 through the communicator 150 or the I/O unit 170.

It would be easily understood by those of ordinary skill in the art that the microphone 161 may be omitted depending on the capabilities or structure of the electronic device 100.

The camera unit 162 may include a lens (not shown) and an image sensor (not shown). The camera unit 162 supports optical zoom or digital zoom by using a plurality of lenses and image processing. A recognition range of the camera unit 162 may be set variously according to a camera angle and peripheral environment conditions. When the camera unit 162 includes a plurality of cameras, a three-dimensional (3D) still image or a 3D motion may be received using the plurality of cameras.

The camera unit 162 may be implemented as an integral or separate type with the electronic device 100. A separate device (not shown) including the separated camera unit 162 is electrically connected with the electronic device 100 through the communicator 150 or the I/O unit 170.

It would be easily understood by those of ordinary skill in the art that the camera unit 162 may be omitted depending on the capabilities or structure of the electronic device 100.

A light receiver 163 receives a light signal (including a control signal) received from an external control device through a lighting window (not shown) of a bezel of the display 115. The light receiver 163 receives a light signal corresponding to a user input (e.g., a touch, a press, a touch gesture, a voice, or a motion) from an external control device. A control signal may be extracted from the received light signal under control of the controller 180.

The I/O unit 170 receives video (e.g., moving images, etc.), audio (e.g., a voice, music, etc.), and additional information (e.g., an EPG, etc.) from an external source outside the electronic device 100, under control of the controller 180. The I/O unit 170 may include one of an HDMI port 171, a component jack 172, a PC port 173, and a USB port 174. The I/O unit 170 may include a combination of the HDMI port 171, the component jack 172, the PC port 173, and the USB port 174.

It would be easily understood by those of ordinary skill in the art that the I/O unit 170 may be omitted depending on the capabilities or structure of the electronic device 100.

The controller 180 controls overall operations of the electronic device 100 and a signal flow among the internal elements 110 through 190 of the electronic device 100, and processes data. The controller 180 executes an operating system (OS) and various applications stored in the storing unit 190, if a user input is input or a preset and stored condition is satisfied.

The controller 180 may include a RAM 181 that stores a signal or data input from an external source or is used as a storage region corresponding to various tasks performed by the electronic device 100, a ROM 182 having stored therein a control program for controlling the electronic device 100, and a processor 183.

The processor 183 may include a graphic processing unit (GPU, not shown) for processing graphics corresponding to video. The processor 183 may be implemented as a system on chip (SoC) in which a core (not shown) and a GPU (not shown) are integrated. The processor 183 may include a single core, a dual core, a triple core, a quad core, and a core of a multiple thereof.

The processor 183 may also include a plurality of processors. For example, the processor 183 may be implemented with a main processor (not shown) and a sub processor (not shown) which operates in a sleep mode.

A GPU 184 generates a screen including various objects such as an icon, an image, a text, etc., by using a calculation unit (not shown) and a rendering unit (not shown). The calculation unit calculates an attribute value such as coordinates, shapes, sizes, colors, etc., of respective objects based on a layout of the screen by using the user's interaction sensed by the sensor 160. The rendering unit generates a screen of various layouts including an object based on the attribute value calculated by the calculation unit. The screen generated by the rendering unit is displayed in a display region of the display 115.

First through n^{th} interfaces 185-1 to 185-n are connected to the above-described elements. One of the interfaces may be a network interface connected with an external device over a network.

The RAM 181, the ROM 182, the processor 183, the GPU 184, and the first through n^{th} interfaces 185-1 to 185-n are interconnected through an internal bus 186.

In the exemplary embodiment, the term “controller” may include the processor 183, the ROM 182, and the RAM 181.

The controller 180 of the electronic device 100 according to an exemplary embodiment may stop providing content if the electronic device 100, while providing the content, determines that the electronic device 100 is in the moving state.

The controller 180 determines that the electronic device 100 is in the moving state based on a sensed the user input with respect to a grip portion mounted on the electronic device 100 being touched by the user.

The controller 180 controls the power supply unit 130 to block power supply to the display 115, if a preset time has elapsed after the electronic device 100 determines that the electronic device 100 is in the moving state.

The controller 180 resumes providing the content if the electronic device 100 exits the moving state.

The controller 180 determines that the electronic device exits the moving state based on the touched user input with respect to the grip portion being released. The controller 180 provides the content continuously from a part of the content corresponding to a point in time when the providing of the content is stopped, if the electronic device 100 determines that the electronic device 100 exits the moving state.

The controller 180 provides an interface as to whether provide the content to the display 115, if the electronic device 100 determines that the electronic device 100 exits. the moving state The controller 180 provides content based on a user input with respect to the interface.

If the electronic device 100 determines that electronic device 100 is in the moving state, the controller 180 stops providing broadcast content having been provided, and controls the broadcast content received through the tuner unit 135 to be recorded from a stop point in time.

It would be easily understood by those of ordinary skill in the art that the controller 180 may be omitted depending on the capabilities or structure of the electronic device 100.

The storing unit 190 stores various data, programs, or applications for driving and controlling the electronic device 100 under control of the controller 180. The storing unit 190 stores input/output signals or data corresponding to driving of the video processor 110, the display 115, the audio processor 120, the audio output unit 125, the power supply unit 130, the tuner unit 140, the communicator 150, the sensor 160, and the I/O unit 170. The storing unit 190 stores a control program for control of the electronic device 100 and the controller 180, an application that is initially provided from a manufacturer or downloaded from an external source, a graphic user interface (GUI) associated with the application, an object (e.g., an image, a text, an icon, a button, etc.) for providing the GUI, user information, a document, databases, or related data.

In an exemplary embodiment, the term “storing unit” may include the storing unit 190, the ROM 182 or the RAM 182 of the controller 180, or a memory card (e.g., a micro secure digital (SD) card, a USB memory, etc., not shown) mounted on the electronic device 100. The storing unit 190 may include a non-volatile memory, a volatile memory, a hard disk drive (HDD), or a solid state drive (SSD).

The storing unit 190 may include a broadcasting reception module, a channel control module, a volume control module, a communication control module, a voice recognition module, a motion recognition module, a light reception module, a display control module, an audio control module, an external input control module, a power control module, a power control module of an external device connected wirelessly (e.g., by Bluetooth), a voice database (DB), or a motion DB. Modules and DBs (not shown) of the storing unit 190 may be implemented in the form of software to perform a control function of broadcasting reception, a channel control function, a volume control function, a communication control function, a voice recognition function, a motion recognition function, a light reception control function, a power control function, or a power control function of an external device connected wirelessly (e.g., by Bluetooth) in the electronic device 100. The controller 180 may perform respective functions by using the foregoing software stored in the storing unit 190.

The electronic device 100 including the display 115 is electrically connected with a separate external device (e.g., a set-top box, not shown) including a tuner unit. It would be easily understood by those of ordinary skill in the art that the electronic device 100 may be implemented with, but not limited to, an analog TV, a digital TV, a 3D TV, a smart TV, an LED TV, an OLED TV, a plasma TV, a monitor, or the like.

At least one element may be added to or removed from the elements (e.g., 110 to 190) of the electronic device 100 illustrated in FIG. 3, depending on capabilities of the electronic device 100. It would also be easily understood that the positions of the elements (e.g., 110 to 190) of the electronic device 100 may be changed depending on the capabilities or structure of the electronic device 100.

FIGS. 4 through 7 are views for describing examples of a grip portion mounted on an electronic device 100, according to exemplary embodiments.

Referring to FIG. 4, a grip portion 50a may be used as a support for the electronic device 100. As illustrated in (a) of FIG. 4, the grip portion 50a is mounted on a rear surface of the electronic device 100. For example, a protrusion provided on a surface of the grip portion 50a may be mounted to be inserted into a groove 10a provided on the rear surface of the electronic device 100 and to move in a slide manner.

Once the grip portion 50a moves up (an arrow direction) as illustrated in (a) of FIG. 4, the grip portion 50a is exposed upward from a top surface of the electronic device 100 to allow the user to hold the grip portion 50a by hand.

The electronic device 100 may include a grip portion sensor 140a for sensing whether the grip portion 50a is touched by the user.

According to an exemplary embodiment, the grip portion sensor 140a is mounted on a portion of a surface that the grip portion sensor 140 becomes contactable when the grip portion 50a enters the user-holdable state, so that the grip portion sensor 140a may determine whether the grip portion 50a is in the user-holdable state.

The grip portion sensor 140a may be implemented with an on/off switch, without being limited to the above description. For example, the grip portion sensor 140a may be implemented with a proximity sensor or a contact sensor. Referring to FIG. 4, when the grip portion sensor 140a is implemented with a proximity sensor or a contact sensor, the grip portion sensor 140a may output a sensing value indicating that the grip portion 50a is in the user-holdable state as the grip portion 50a moves up.

According to an exemplary embodiment, the grip portion sensor 140a may also be implemented with a touch sensor capable of sensing a user's touch input contacting the grip portion 50a.

Referring to FIG. 5, when the electronic device 100 is not in the moving state, a grip portion 50b may be used as a support for the electronic device 100. As illustrated in (a) of FIG. 5, the grip portion 50b is mounted on the rear surface of the electronic device 100. For example, the grip portion 50b may be implemented as a triangular support.

Once the grip portion 50b moves up (an arrow direction) in a foldable manner as illustrated in (a) of FIG. 5, the grip portion 50b is exposed upward from a top surface of the electronic device 100 to allow the user to hold the grip portion 50b by hand.

The electronic device 100 may include the grip portion sensor 140a for sensing whether the grip portion 50b is in the user-holdable state.

According to an exemplary embodiment, the grip portion sensor 140a is mounted on a portion of a surface that the grip portion sensor 140a becomes contactable when the grip portion 50b enters the user-holdable state, so that the grip portion sensor 140a may determine whether the grip portion 50b is in the user-holdable state.

The grip portion sensor 140a may be implemented with an on/off switch, without being limited to the above description. For example, the grip portion sensor 140a may be implemented with a proximity sensor or a contact sensor. Referring to FIG. 5, when the grip portion sensor 140a is implemented with a proximity sensor or a contact sensor, the grip portion sensor 140a may output a sensing value indicating that the grip portion 50a is in the user-holdable state as the grip portion 50b is folded up.

According to an exemplary embodiment, the grip portion sensor 140a may also be implemented with a touch sensor capable of sensing a user's touch input contacting the grip portion 50b. Referring to (a) of FIG. 6, when a grip portion 50c is not currently used by the user, the grip portion 50c may be inserted into and closely contact with the electronic device 100. When the grip portion 50c closely contacts the electronic device 100, the grip portion 50c may be raised from the electronic device 100 or drawn from the electronic device 100 (see (b) of FIG. 6), if the user puts the hand between the grip portion 50c and the electronic device 100 to hold the grip portion 50c upward (an arrow direction).

According to an exemplary embodiment, the grip portion sensor 140a senses if the grip portion 50c is in the user-holdable state. The grip portion sensor 140a may be mounted inside the electronic device 100 as illustrated in (a) of FIG. 6, but the mounting position of the grip portion sensor 50c is not limited to this illustration.

According to an exemplary embodiment, the grip portion sensor 140a may be implemented with a on/off switch. Referring to (a) of FIG. 6, the grip portion sensor 140a may enter an on state if the grip portion 50c is pulled out from the electronic device 100 (an arrow direction), but an operation of the grip portion sensor 50c is not limited to this illustration. For example, the grip portion sensor 140a may enter an off state if the grip portion 50c is pulled out from the electronic device 100.

According to an exemplary embodiment, the grip portion sensor 140a may also be implemented with a touch sensor capable of sensing a user's touch input contacting the grip portion 50c.

The grip portion sensor 140a according to an exemplary embodiment is not limited to the on/off switch.

For example, the grip portion sensor 150a may also be implemented with a touch sensor capable of sensing a user's touch input. The grip portion sensor 140a implemented with a touch sensor may be disposed to sense a touch input of the user contacting the grip portion 50. Once the user holds the grip portion 50, the grip portion sensor 140a senses that the electronic device 100 has been held or touched by the user.

For example, the grip portion sensor 140a may be implemented with a light sensor. If the grip portion sensor 140a is implemented with a light sensor including a light emitter and a light receiver, the light receiver receives light emitted from the light emitter when the grip portion 50c is pulled out from the electronic device 100, such that the grip portion sensor 140a may sense that the grip portion 50c is pulled out from the electronic device 100.

According to an exemplary embodiment, a sensing value output from the grip portion sensor 140a may be transmitted to the electronic device 100. The electronic device 100 may determine based on the sensing value of the grip portion sensor 140a whether the grip portion 50 is in the user-holdable state or touched by the user.

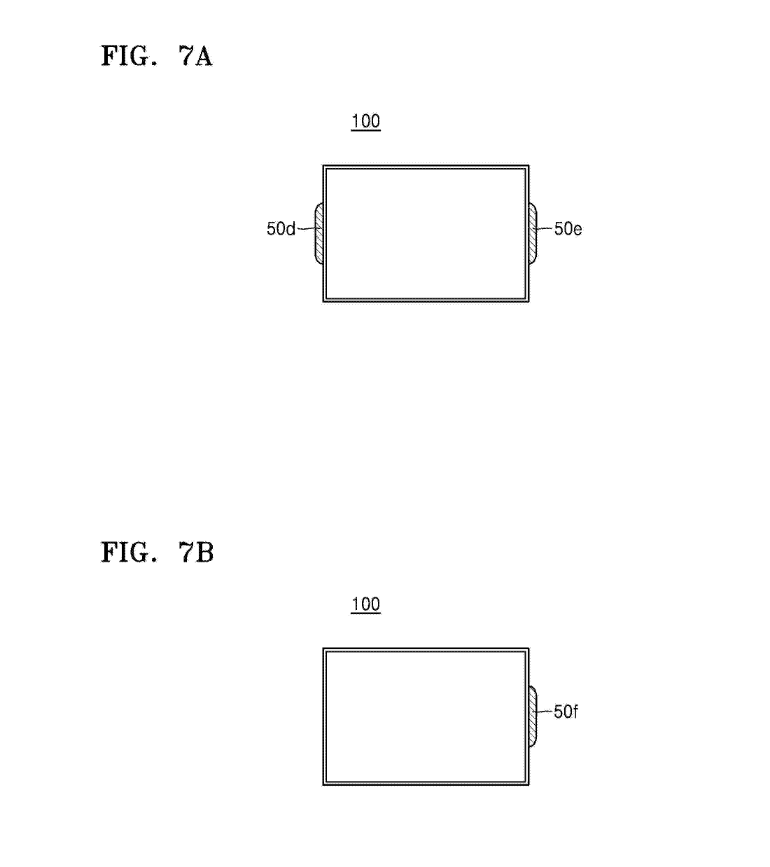

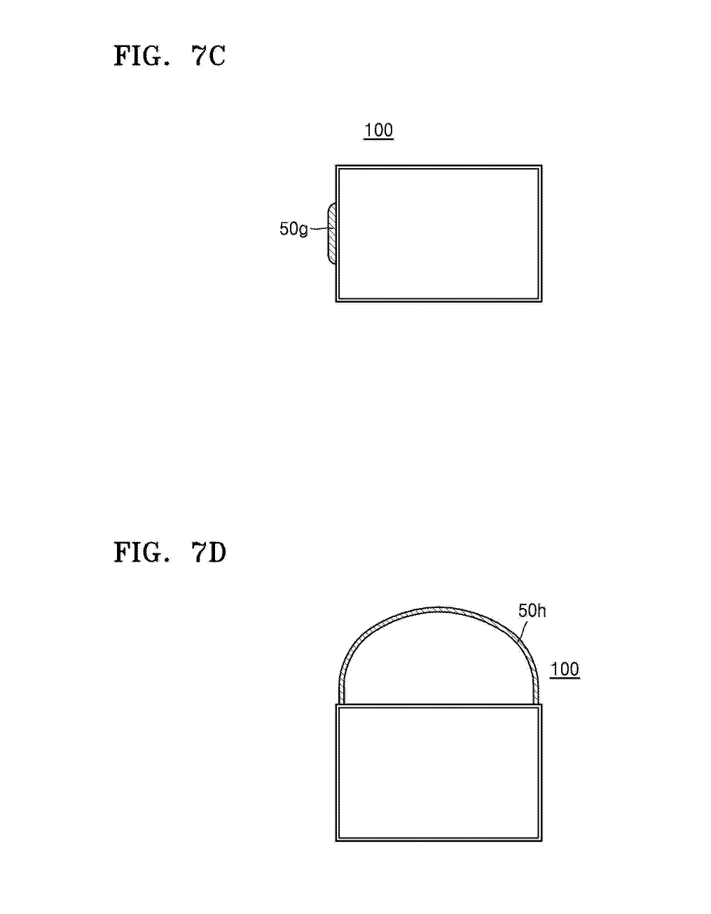

FIGS. 7A-7D illustrate other examples of a grip portion mounted on the electronic device 100 according to an exemplary embodiment.

Referring to (a) of FIG. 7, grip portions 50d and 50e are mounted on a left side and a right side of the electronic device 100, respectively. In (a) of FIG. 7, the grip portion sensor 140a for sensing whether the grip portion is used may be mounted near the grip portion mounted on each of the left side and the right side.

Referring to (b) of FIG. 7, a grip portion 50f is mounted on the right side of the electronic device 100. In (b) of FIG. 7, the grip portion sensor 140a for sensing whether the grip portion 50f is used may be mounted near the grip portion 50f mounted on the right side.

Referring to (c) of FIG. 7, a grip portion 50g is mounted on the left side of the electronic device 100. In (c) of FIG. 7, the grip portion sensor 140a for sensing whether the grip portion 50g is used may be mounted near the grip portion 50g mounted on the left side.

Referring to (d) of FIG. 7, a grip portion 50h is mounted on the electronic device 100 in the form of a string. In (d) of FIG. 7, the grip portion sensor 140a for sensing whether the grip portion 50h is mounted on a connecting portion connecting the grip portion 50h with the electronic device 100 or on a portion of a surface of the grip portion 50h facing the electronic device 100.

The grip portions 50a through 50h illustrated in FIGS. 4 through 7 may be formed of the same material as a material of the exterior of the electronic device 100. For example, the exterior of the electronic device 100 and the grip portions 50a through 50h may be formed of a plastic material. The grip portions 50a through 50h may be formed of a material that is different from the material of the exterior of the electronic device 100. For example, the exterior of the electronic device 100 may be formed of a plastic material, whereas the grip portions 50a through 50h may be formed of a material such as leather, synthetic leather, fabrics, iron, or the like.

FIGS. 4 through 7 illustrate an exemplary embodiment, and the present disclosure is not limited thereto.

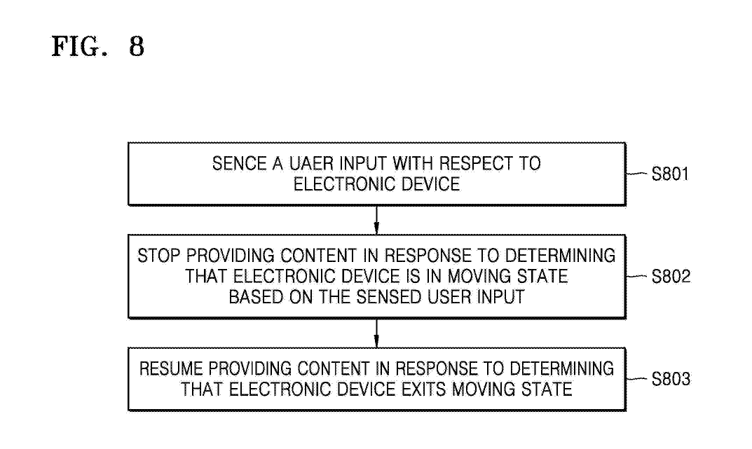

FIG. 8 is a flowchart illustrating a method of controlling an electronic device according to an exemplary embodiment.

In operation S801 of FIG. 8, the sensor 140 senses a user input with respect to the electronic device 100. The electronic device 100 comprises a grip portion mounted on the electronic device 100. The sensor 140 may sense the user input in response to the grip portion being touched by the user.

According to an exemplary embodiment, the controller 180 provides content when the electronic device 100 is not in the moving state. For example, the user may watch video on the electronic device 100 placed on a table. The providing of content by the electronic device 100 has been described in the foregoing description referring to FIG. 1, and thus a detailed description thereof will not be provided.

In operation S802 of FIG. 8, the controller 180 stops providing the content in response to determining that the electronic device 100 is in the moving state based on the sensed user input by the sensor 140.

According to an exemplary embodiment, the controller 180 of the electronic device 100 determines through the sensor 140 whether the electronic device 100 is in the moving state.

According to an exemplary embodiment, the sensor 140 may include the grip portion sensor 140a. The controller 180 determines that the electronic device 100 is in the moving state, once sensing through the grip portion sensor 140a that the grip portion 50 is touched by the user.

According to an exemplary embodiment, the sensor 140 may include the motion sensor 140b. The controller 180 determines that the electronic device 100 is in the moving state, as sensing a motion of the electronic device 100 through the motion sensor 140b.

The motion sensor 140b senses that the electronic device 100 is on the move. According to an exemplary embodiment, the motion sensor 140b may refer to, but not limited to, at least one of the acceleration sensor 142, the gyroscope sensor 145, the geomagnetic sensor 141, and a gravity sensor.

In operation S802 of FIG. 8, the controller 180 stops providing content if determining that the electronic device 100 is in the moving state.

For example, the user having watched video through the electronic device 100 placed on the table may hold the grip portion 50 of the electronic device 100 to move to another place. The electronic device 100 stops playing video, if sensing through the grip portion sensor 140a or the motion sensor 140b that the electronic device 100 is in the moving state.

In operation S803 of FIG. 8, the controller 180 resumes providing the content in response to determining that the electronic device 100 exits the moving state.

According to an exemplary embodiment, the controller 180 of the electronic device 100 determines through the sensor 140 including the grip portion sensor 140a or the motion sensor 140b that the electronic device 100 is not in the moving state.

According to an exemplary embodiment, the controller 180 determines that the electronic device 100 exits the moving state based on the touched user input with respect to the grip portion 50 being released.

For example, if the user arrives at a destination, holding the grip portion 50 of the electronic device 100, and places the electronic device 100 on the table, then the controller 180 of the electronic device 100 may determine through the grip portion sensor 140a or the motion sensor 140b that the electronic device 100 is not in the moving state. In this case, the controller 180 of the electronic device 100 resumes providing the content.

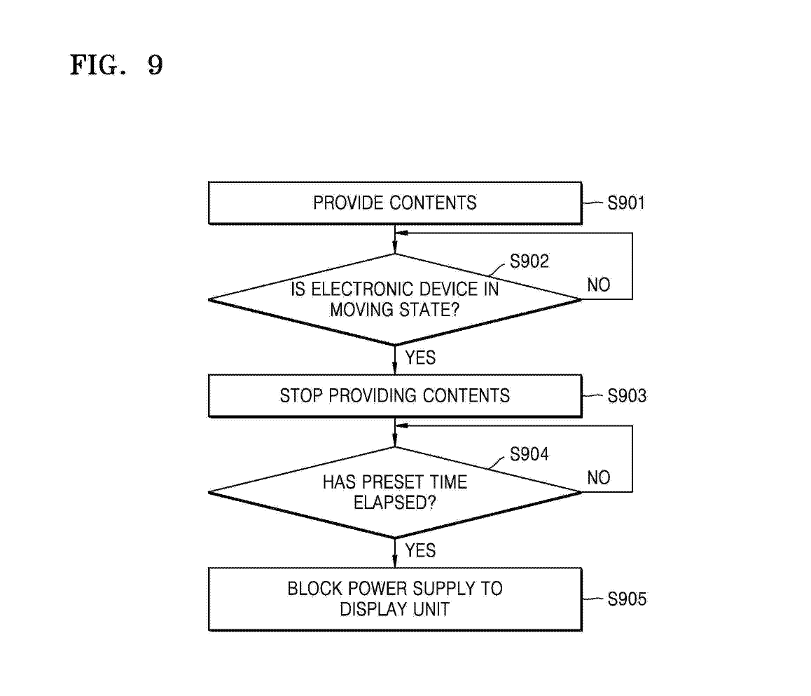

FIG. 9 is a flowchart for describing an example in which power supply to a display of an electronic device is blocked, according to an exemplary embodiment.

In operation S901 of FIG. 9, the controller 180 provides content. In operation S902, the controller 180 determines whether the electronic device 100 is in the moving state. In operation S903, the controller 180 stops providing content if determining that the electronic device 100 is in the moving state in operation S902. Operations S901, S902, and S903 have been described in the description of operations S801 and S802 of FIG. 8, and thus will not be described in detail.

In operation S904 of FIG. 9, the controller 180 determines whether a preset time has elapsed. According to an exemplary embodiment, the controller 10 determines whether a preset time has elapsed after the electronic device 100 determines that the electronic device 100 is in the moving state.

In operation S905 of FIG. 9, the controller 180 stops power supply to the display 115 if determining that the preset time has elapsed in operation S904.

According to an exemplary embodiment, the controller 180 senses through the sensor 140 whether the electronic device 100 is in the moving state. The controller 180 controls the power supply unit 130 to block the power supply to the display 115 and thus turns off the display 115, if a duration of the moving state of the electronic device 100 exceeds the preset time. Consequently, power consumption of the battery may be reduced.

Moreover, according to an exemplary embodiment, the electronic device 100 controls the power supply unit 130 to block power supply to another element of the electronic device 100, if the preset time has elapsed again from the blocking of the power supply to the display 115 in operation S905.

For example, the electronic device 100 may control the power supply unit 130 to block power supply to elements other than minimum elements, such as the sensor 140 for determining whether the electronic device 100 is in the moving state, the RAM for memorizing a task being in progress in the electronic device 100, or the like, thereby minimizing the power consumption of the battery.

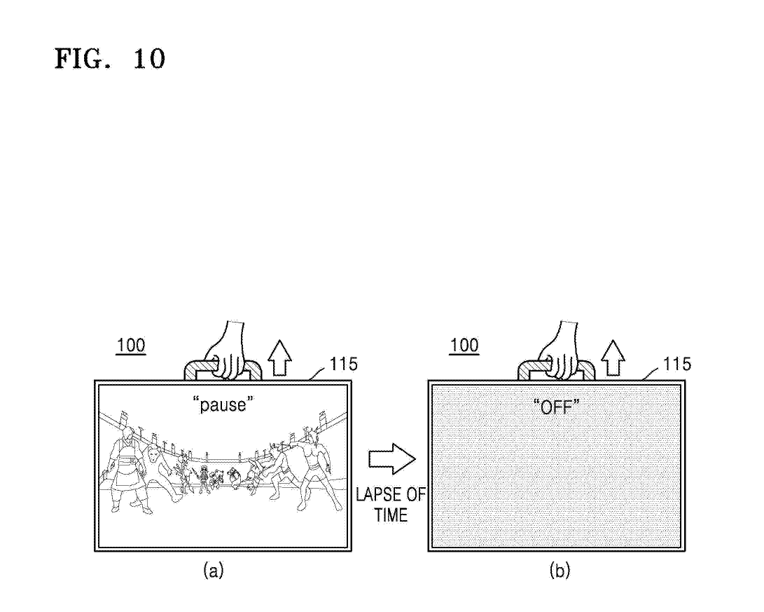

FIG. 10 is a view for describing an example in which power supply to a display of an electronic device is blocked, according to an exemplary embodiment.

As illustrated in (a) of FIG. 10, when the electronic device 100 is in the moving state, an image corresponding to a point in time when the playback of the content is stopped may be displayed on the display 115.

Referring to (b) of FIG. 10, if a preset time has elapsed as the moving state of the electronic device 100 is maintained, the controller 180 controls the power supply unit 130 to block the power supply to the display 115, thereby turning off the display 115. Consequently, power consumption of the battery of the electronic device 100 may be reduced.

FIG. 10 illustrates an exemplary embodiment, and the present disclosure is not limited thereto.

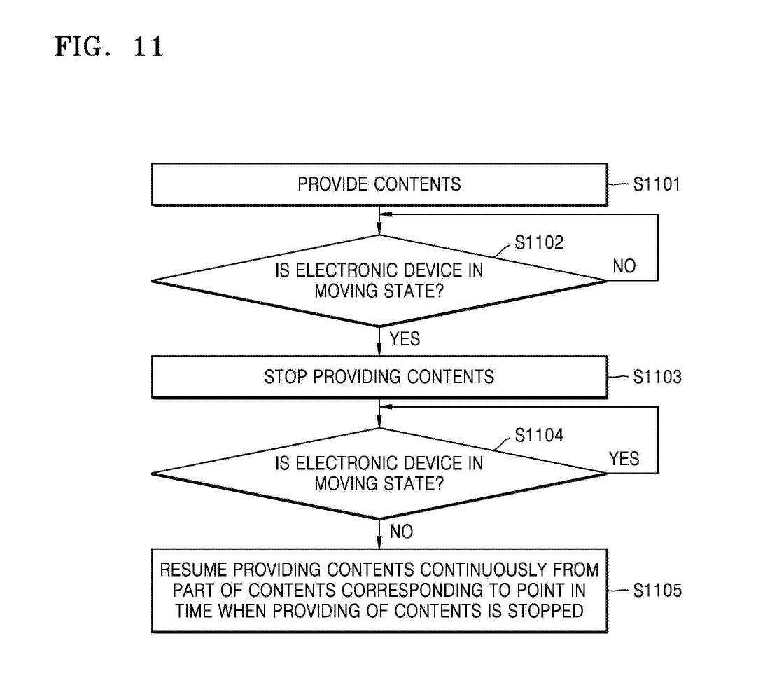

FIG. 11 is a flowchart for describing an example in which content is automatically provided, according to an exemplary embodiment.

In operation S1101 of FIG. 11, the controller 180 provides content. In operation S1102, the controller 180 determines whether the electronic device 100 is in the moving state. In operation S1103, the controller 180 stops providing content if determining that the electronic device 100 is in the moving state in operation S1102. Operations S1101, S1102, and S1103 have been described in the description of operations S801 and S802 of FIG. 8, and thus will not be described in detail.

In operation S1104 of FIG. 11, the controller 180 determines whether the electronic device 100 is in the moving state. According to an exemplary embodiment, the controller 180 senses through the sensor 140 whether the electronic device 100 is in the moving state.

In operation S1105 of FIG. 11, the controller 180 resumes providing the content continuously from a part of the content corresponding to the point in time when the providing of the content is stopped, if determining that the electronic device 100 is not in the moving state in operation S1104.

According to an exemplary embodiment, the controller 180 of the electronic device 100 resumes providing the content continuously from the part of the content corresponding to the point in time when the providing of the content is stopped, if the electronic device 100 determines that the electronic device 100 exits the moving state. For example, the electronic device 100 resumes playing video continuously from the part of the video corresponding to the point in time when the providing of the content is stopped in operation S1103, allowing the user to continuously watch the video without any missing part of the video even after moving to another place.

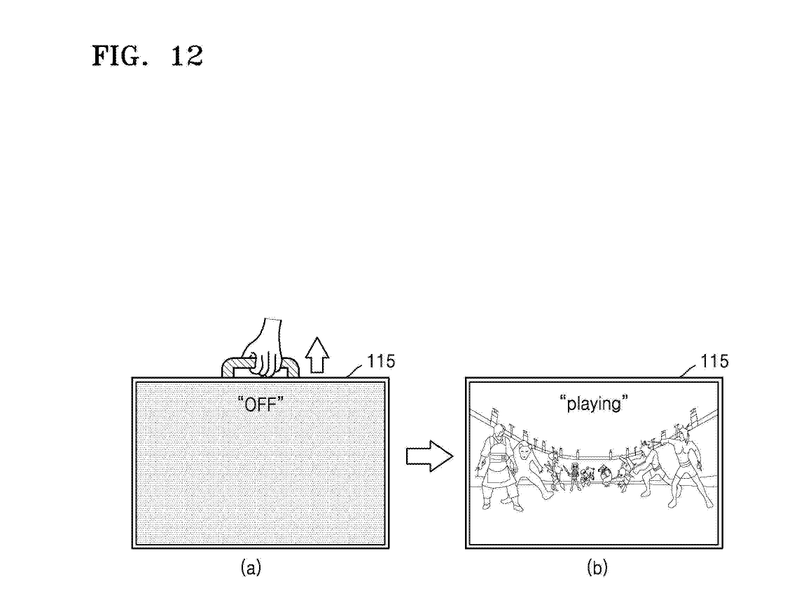

FIG. 12 is a view for describing an example in which content is automatically provided, according to an exemplary embodiment.

As illustrated in (a) of FIG. 12, the display 115 is turned off when the electronic device 100 is in the moving state. For example, the controller 180 controls the power supply unit 130 to block the power supply to the display 115 and thus turns off the display 115, if a preset time has elapsed after determining that the electronic device 100 is in the moving state.

Referring to (b) of FIG. 12, the controller 180 automatically resumes providing content continuously from a part of the content corresponding to the point in time when the providing of the content is stopped, if the electronic device 100 determines that the electronic device 100 is not in the moving state. As a result, the user may continuously watch the video played before the user moves, without separate manipulation for playing the video.

FIG. 12 illustrates an exemplary embodiment, and the present disclosure is not limited thereto.

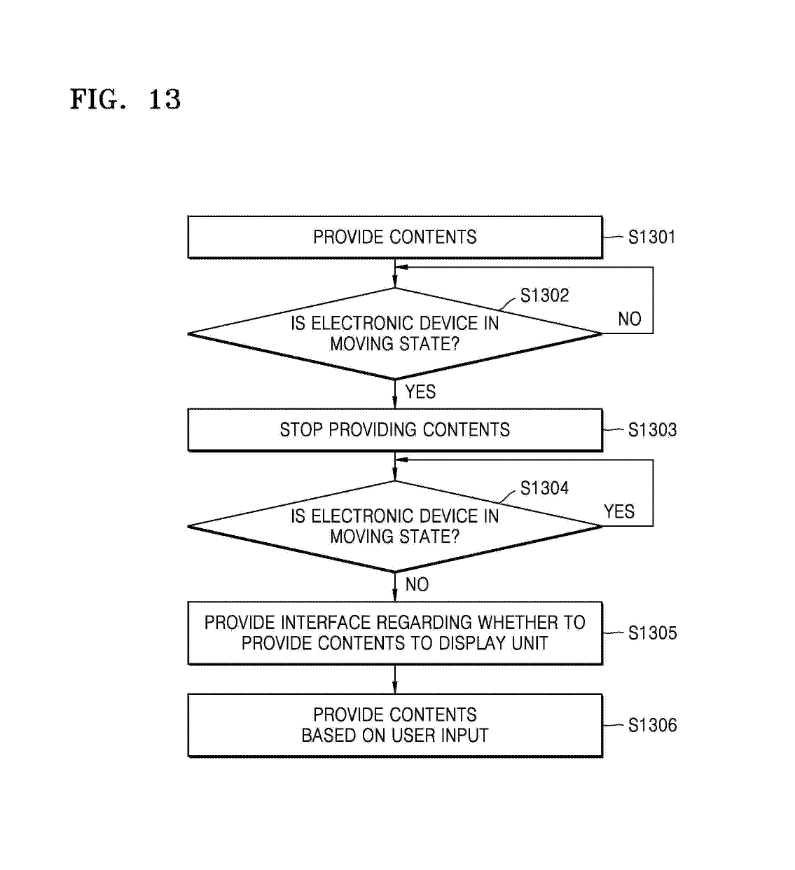

FIG. 13 is a flowchart for describing an example in which content is provided based on a user input, according to an exemplary embodiment.

In operation S1301 of FIG. 13, the controller 180 provides content. In operation S1302, the controller 180 determines whether the electronic device 100 is in the moving state. In operation S1303, the controller 180 stops providing content if determining that the electronic device 100 is in the moving state in operation S1302. Operations S1301, S1302, and S1303 have been described in the description of operations S801 and S802 of FIG. 8, and thus will not be described in detail.

In operation S1304 of FIG. 13, the controller 180 determines whether the electronic device 100 is in the moving state. According to an exemplary embodiment, the controller 180 senses through the sensor 140 whether the electronic device 100 is in the moving state.

In operation S1305 of FIG. 13, the controller 180 provides an interface regarding whether to provide the content to the display 115, if determining that the electronic device 100 is not in the moving state in operation S1304. According to an exemplary embodiment, the controller 180 provides a screen for allowing the user to select whether to resume playing the content to the display 115, if the electronic device 100 exits the moving state.

In operation S1306 of FIG. 13, the controller 180 provides the content based on a user input with respect to the interface. According to an exemplary embodiment, the electronic device 100 resumes playing the content, upon receiving a user input for selecting to resume playing the content continuously from a part of the content corresponding to a point in time when the providing of the content is stopped.

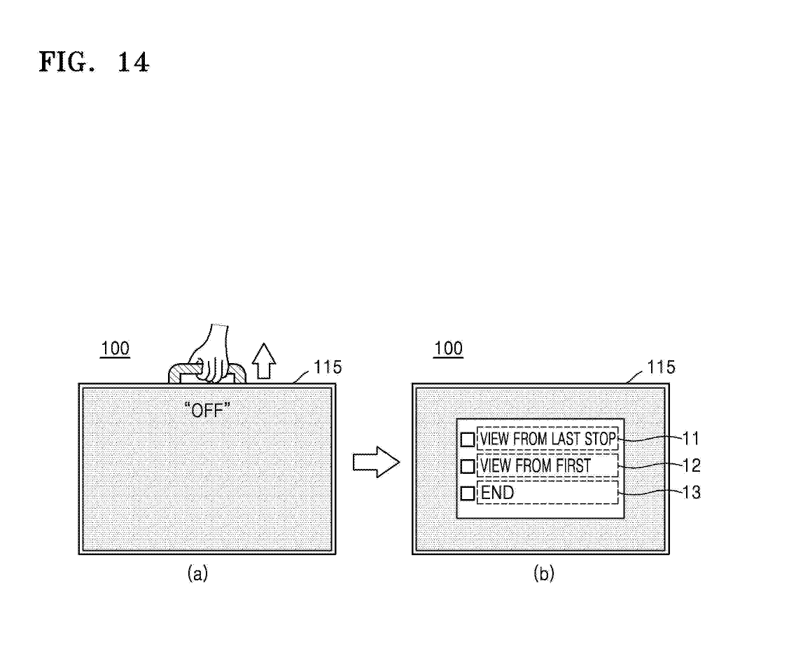

FIG. 14 is a view for describing an example in which content is provided based on a user input, according to an exemplary embodiment.

As illustrated in (a) of FIG. 14, the display 115 is turned off when the electronic device 100 determines that the electronic device 100 is in the moving state. For example, the controller 180 controls the power supply unit 130 to block the power supply to the display 115 and thus turns off the display 115, if a preset time has elapsed after the electronic device 100 determines that the electronic device 100 is in the moving state.

Referring to (b) of FIG. 14, the controller 180 provides an interface screen associated with selection of whether to resume playing the content to the display 115, if the electronic device 100 exits the moving state.

For example, if the electronic device 100 stops playing the content because of being in the moving state, the electronic device 100 may display, on the display 115, a selection menu 11 (e.g., ‘view from the last stop’) for continuously viewing the content from the point in time when the playback of the content is stopped.

For example, if the electronic device 100 stops playing the content because of being in the moving state, the electronic device 100 may also display, on the display 115, a selection menu 12 (e.g., ‘view from the first’) for viewing the content from the first part of the content the user has watched.

For example, if the electronic device 100 stops playing the content because of being in the moving state, the electronic device 100 may also display, on the display 115, a selection menu 13 (e.g., ‘end’) for ending the content the user has watched without resuming playing the content.

FIG. 14 illustrates an exemplary embodiment, and the present disclosure is not limited thereto.

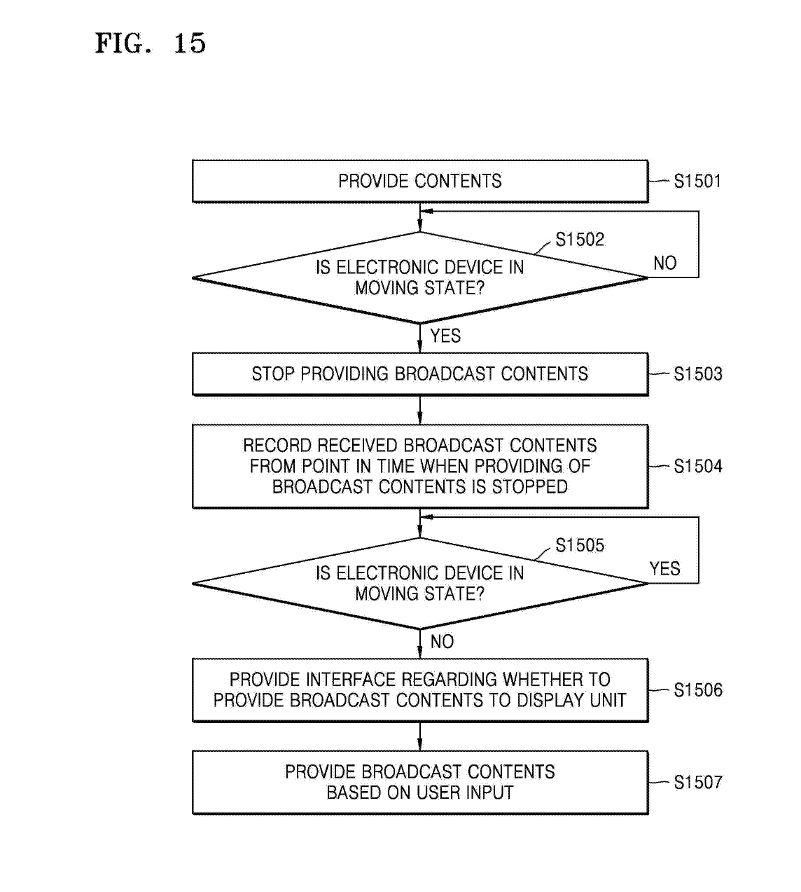

FIG. 15 is a flowchart for describing an example in which broadcasting content is recorded, according to an exemplary embodiment.

In operation S1501 of FIG. 15, the controller 180 provides broadcast content. According to an embodiment, the electronic device 100 provides the broadcast content received through the tuner unit 135 to the display 115.

In operation S1502 of FIG. 15, the controller 180 determines whether the electronic device 100 is in the moving state. In operation S1503, the controller 180 stops providing the content if determining that the electronic device 100 is in the moving state in operation S1502. Operations S1502 and S1503 have been described in the description of operations S801 and S802 of FIG. 8, and thus will not be described in detail.

In operation S1504 of FIG. 15, the controller 180 records the received broadcast content from a part of the broadcast content corresponding to the point in time when the providing of the broadcast content is stopped.

According to an exemplary embodiment, the electronic device 100 stops providing the broadcast content and records and stores the broadcast content in the storing unit 190 from a part of the broadcast content corresponding to the point in time when the providing of the content is stopped, if the electronic device 100 determines that the electronic device 100 is in the moving state while providing the broadcast content.

In operation S1505 of FIG. 15, the controller 180 determines whether the electronic device 100 is in the moving state. According to an exemplary embodiment, the controller 180 senses through the sensor 140 whether the electronic device 100 is in the moving state.

In operation S1506 of FIG. 15, the controller 180 provides an interface regarding whether to provide the broadcast content to the display 115, if determining that the electronic device 100 is not in the moving state in operation S1505. According to an exemplary embodiment, the electronic device 100 provides a screen for allowing the user to select whether to resume providing the broadcast content to the display 115, if the electronic device 100 exits the moving state.

In operation S1507 of FIG. 15, the controller 180 provides the broadcast content based on a user input. According to an exemplary embodiment, the electronic device 100 resumes providing the broadcast content, upon receiving a user input for selecting to continue watching the broadcast content.

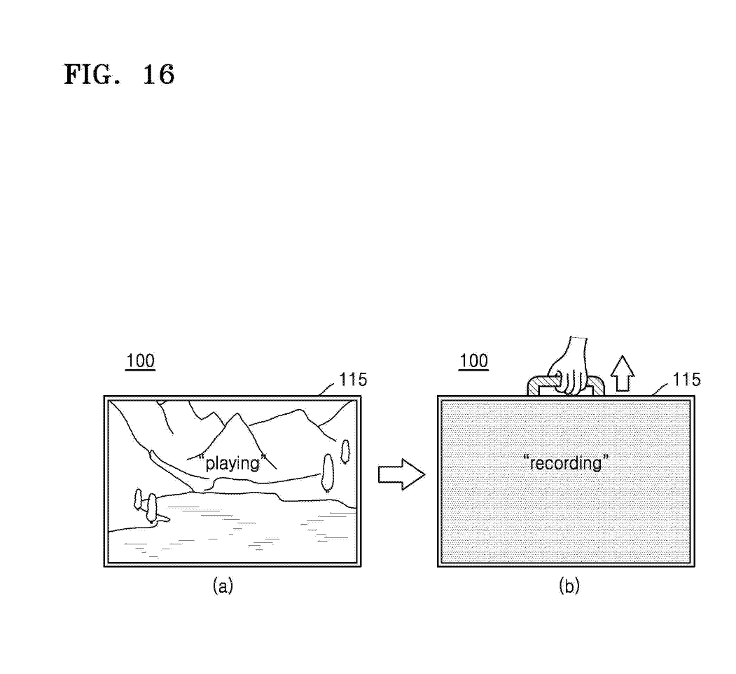

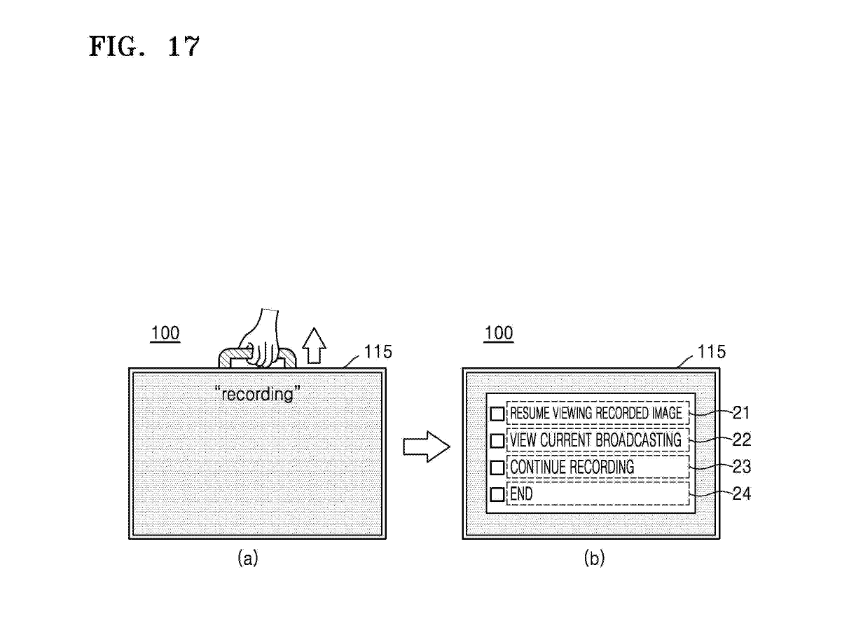

FIGS. 16 through 17 are views for describing an example in which broadcasting content is recorded, according to an exemplary embodiment.

As illustrated in (a) of FIG. 16, the electronic device 100 provides the broadcast content received through the tuner unit 135 to the display 115.

Referring to (b) of FIG. 16, the controller 180 stops providing the broadcast content when the electronic device 100 determines that the electronic device 100 exits the moving state.

According to an exemplary embodiment, as stopping providing the broadcast content, the electronic device 100 controls the power supply unit 130 to block power supply to the display 115.

According to an exemplary embodiment, as stopping providing the broadcast content, the electronic device 100 displays, on the display 115, a still image corresponding to a point in time the providing of the broadcast content is stopped. Thereafter, if a preset time has elapsed, the electronic device 100 controls the power supply unit 130 to block power supply to the display 115.

As illustrated in (b) of FIG. 16, the electronic device 100 according to an exemplary embodiment records the broadcast content received through the tuner unit 135 from a part of the broadcast content corresponding to the point in time when the providing of the broadcast content is stopped.

According to an exemplary embodiment, even if the user moves to another place when watching broadcast content, the electronic device 100 provides a function of recording the broadcast content to allow the user to watch the broadcast content later without any missing part of the broadcast content.

(a) of FIG. 17 shows that when the moving state of the electronic device 100 is maintained, the broadcast content received through the tuner unit 135 may be recorded from a part of the broadcast content corresponding to a point in time when the providing of the broadcast content is stopped, as described with reference to (b) of FIG. 16.

Referring to (b) of FIG. 17, the controller 180 provides an interface screen associated with selection of whether to provide the broadcast content to the display 115, if the electronic device 100 exits the moving state.

For example, if the electronic device 100 stops playing the content because of being in the moving state, the electronic device 100 may display, on the display 115, a selection menu 21 (e.g., ‘resume viewing recorded image’) for continuously viewing the broadcast content from a part of the broadcast content corresponding to the point in time when the providing of the content is stopped.

As the electronic device 100 plays the recorded image, the user may watch the broadcast content continuously from a part of the broadcast content corresponding to the point in time when the viewing of the broadcast content is stopped.

For example, if the electronic device 100 stops playing the broadcast content because of being in the moving state, the electronic device 100 may display, on the display 115, a selection menu 22 (e.g., ‘view current broadcasting’) for viewing broadcast content currently received through the tuner unit 135. The electronic device 100 displays the broadcast content received through the tuner unit 135 on the display 115, thereby providing a real-time broadcast image to the user.

For example, if the electronic device 100 stops providing the broadcast content because of being in the moving state, the electronic device 100 may display, on the display 115, a selection menu 23 (e.g., ‘continue recording’) for continuing recording even when the electronic device 100 is not in the moving state. The electronic device 100 continues recording the broadcast content received through the tuner unit 135.

For example, if the electronic device 100 stops providing the broadcast content because of being in the moving state, the electronic device 100 may also display, on the display 115, a selection menu 24 (e.g., ‘end’) for ending the broadcast content the user has watched without resuming watching the broadcast content.

(b) of FIG. 17 shows an example where an interface screen associated with selection of whether to provide broadcast content if the electronic device 100 exits the moving state, but the present disclosure is not limited thereto.

According to an exemplary embodiment, if the electronic device 100 switches from the moving state to the cradling state, the electronic device 100 may automatically and immediately provide the broadcast content (see (a) of FIG. 16) provided in the cradling state of the electronic device 100. For example, if the electronic device 100 switches from the moving state to the cradling state, the electronic device 100 plays the recorded image, allowing the user to immediately watch the broadcast content continuously from the part of the broadcast content corresponding to the point in time when the viewing of the broadcast content is stopped.

FIGS. 16 through 17 illustrate exemplary embodiments, and the present disclosure is not limited thereto.

The above-described exemplary embodiments are illustrative, and may be understood as not being restrictive. Orders of operations are not limited to those illustrated in the flowcharts of FIGS. 8, 9, 11, 13, and 15, and it would be understood that some operations may be omitted or added and orders of some operations may be changed according to various exemplary embodiments.

Some exemplary embodiments may be implemented with a recording medium including a computer-executable command such as a computer-executable programming module. A computer-readable recording medium may be an available medium that is accessible by a computer, and includes all of a volatile medium, a non-volatile medium, a separated medium, and a non-separated medium. The computer-readable recording medium may also include both a computer storage medium and a communication medium. The computer storage medium includes all of a volatile medium, a non-volatile medium, a separated medium, and a non-separated medium, which is implemented by a method or technique for storing information such as a computer-readable command, a data structure, a programming module, or other data. The communication medium includes a computer-readable command, a data structure, a programming module, or other data of a modulated data signal like carriers, or other transmission mechanisms, and includes an information delivery medium.

In the specification, the term “unit” may be a hardware component like a processor or a circuit, and/or a software component executed by a hardware component like a processor.

Those of ordinary skill in the art to which the present disclosure pertains will appreciate that the present disclosure may be implemented in different detailed ways without departing from the technical spirit or essential characteristics of the present disclosure. Accordingly, the aforementioned exemplary embodiments should be construed as being only illustrative, but should not be constructed as being restrictive from all aspects. For example, each element described as a single type may be implemented in a distributed manner, and likewise, elements described as being distributed may be implemented as a coupled type.

The scope of the present disclosure is defined by the following claims rather than the detailed description, and the meanings and scope of the claims and all changes or modified forms derived from their equivalents should be construed as falling within the scope of the present disclosure.

What is claimed is:

1. An electronic device for providing content, the electronic device comprising:
a sensor configured to sense a user input with respect to the electronic device; and
a controller configured to stop providing the content in response to determining that the electronic device is in a moving state based on the sensed user input while providing the content, and to resume providing the content in response to determining that the electronic device exits the moving state.

2. The electronic device of claim 1, wherein, in response to determining that the electronic device exits the moving state, the controller is configured to resume providing the content from a part of the content being provided at a point in time when the providing the content is stopped.

3. The electronic device of claim 1 further comprising a grip portion mounted on the electronic device,
wherein the sensor is configured to sense the user input in response to the grip portion being touched by the user.

4. The electronic device of claim 3, wherein the controller is configured to determine that the electronic device exits the moving state based on the touched user input with respect to the grip portion being released.

5. The electronic device of claim 1, further comprising:
a power supply unit configured to supply power; and
a display,
wherein the controller is configured to control the power supply unit to stop supplying the power to the display in response to a preset time being elapsed after determining that the electronic device is in the moving state.

6. The electronic device of claim 1, further comprising a display,
wherein the display is configured to provide an interface for a user to input whether to provide the content in response to determining that the electronic device exits the moving state; and
wherein the controller is configured to resume providing the content based on the user input with respect to the interface.

7. The electronic device of claim 1, further comprising a tuner unit configured to receive broadcast content,
wherein the controller is configured to stop providing the broadcast content and to record the broadcast content received from a point in time when the providing the broadcast content is stopped in response to determining that the electronic device is in the moving state.

8. A method of providing content, the method comprising:
sensing a user input with respect to an electronic device;
stopping providing the content in response to determining that the electronic device is in a moving state based on the sensed user input while providing the content; and
resuming providing the content in response to determining that the electronic device exits the moving state.

9. The method of claim 8, wherein the resuming providing the content comprises providing the content from a part of the content being provided at a point in time when the providing the content is stopped.

10. The method of claim 8, wherein the sensing the user input comprises sensing the user input in response to a grip portion mounted on the electronic device being touched by the user.

11. The method of claim 10, wherein the resuming providing the content comprises determining that the electronic device exits the moving state based on the touched user input with respect to the grip portion being released.

12. The method of claim 8, further comprising controlling a power supply unit to stop supplying power to a display in response to a preset time being elapsed after determining that the electronic device is in the moving state.

13. The method of claim 8, wherein the resuming providing the content comprises:
providing an interface for a user to input whether to provide the content to a display in response to determining that the electronic device exits the moving state; and
providing the content based on the user input with respect to the interface.

14. The method of claim 8, wherein the stopping providing the content comprises stopping providing broadcast content and recording the broadcast content received from a point in time when the providing the broadcast content is stopped in response to determining that the electronic device is in the moving state.

15. A non-transitory computer-readable recording medium having recorded thereon a program for executing the method according to claim 8.
